(19) United States
(12) Patent Application Publication
(10) Pub. No.: US 2014/0351081 A1
(43) Pub. Date: Nov. 27, 2014

(54) METHOD AND DEVICE FOR DETERMINING INFORMATION PROCESSING TARGET

(71) Applicant: Beijing Jingdong Century Trading Co., Ltd., Beijing (CN)

(72) Inventor: Yang YANG, Beijing (CN)

(21) Appl. No.: 14/144,693

(22) Filed: Dec. 31, 2013

(30) Foreign Application Priority Data
May 24, 2013 (CN) 201310199361.9

(51) Int. Cl. G06Q 30/06

(52) U.S. Cl. CPC G06Q 30/0633
USPC 705/26.8

(57) ABSTRACT

The present invention provides a method and device for determining an information processing target, which can determine an account of an E-commerce buyer or a terminal used by a buyer to be monitored. The method comprises: saving mapping networks formed of many-to-many correspondences between a plurality of user accounts and a plurality of terminals, the terminals being those that are used when at least one of the user accounts are logged in; and using, in the case that a mapping network contains a pre-specified user account or terminal, the user account and/or terminal in the mapping network as an information processing target, and processing the information processing target in a preset processing manner.

### CROSS-REFERENCE

This application claims foreign priority benefits to Chinese Patent Application No. 201310199361.9 filed May 24, 2013 and is incorporated herein by reference in its entirety.

### BACKGROUND

The present invention relates to a method and device for determining an information processing target.

In the actual operation of E-commerce, a malicious placement of an order will often occur, which is generally in the form of placing a large amount of orders within a short period of time and brings losses to the buyers and the sellers. In order to stop the behavior of maliciously placing an order, it is necessary to first determine the suspicious account which maliciously places an order. One current method adopted is to use a blacklist, in which the accounts which have once performed a behavior of maliciously placing an order are placed, and the behaviors of these accounts are monitored. However, With respect to this method, the user who maliciously places an order can get around the monitoring by changing the account used, so that the target to be monitored cannot be determined.

Another currently adopted method is to create an identification on the terminal used by the user when the user places an order, and achieve the tracking on the identification by acquiring the identification saved on the terminal used by the user when the user places the order. Since the user uses the same terminal to place the order, even if the user changes his account, the user's behavior of placing an order can be still monitored by tracking the identification. This approach of creating an identification on the terminal generally adopts a cookie-related technique or a flash-cookie-related technique to achieve the recording of the cross-browser cookies. But a person who maliciously places an order will frequently change the terminals used, and in this case, the target to be monitored still cannot be determined.

### SUMMARY

In view of the above, the present invention provides a method and device for determining an information processing target, which can determine an account of an E-commerce buyer or a terminal used by a buyer to be monitored.

In order to achieve the above object, a method for determining an information processing target is provided according to one aspect of the present invention.

The method for determining an information processing target of the present invention comprises: saving mapping networks formed of many-to-many correspondences between a plurality of user accounts and a plurality of terminals, the terminals being those that are used when at least one of the user accounts are logged in; and using, in the case that a mapping network contains a pre-specified user account or terminal, the user account and/or terminal in the mapping network as an information processing target, and processing the information processing target in a preset processing manner.

Optionally, the saved mapping networks are plural; and in the case that the user account is logged in using a terminal in another mapping network different from the mapping network where the user account is located, the other mapping network and the mapping network where the user account is located are combined into a single mapping network.

Optionally, the step of saving mapping networks formed of many-to-many correspondences between a plurality of user accounts and a plurality of terminals comprises: after a first user account is logged in, transmitting a first identification to a first terminal used to log into the first user account, and saving the first user account and the first identification in a corresponding relationship in a first mapping network; in the case that the first user account is logged in again using a second terminal, transmitting a second identification to the second terminal, and saving the second identification and the first user account in a corresponding relationship in the first mapping network; and in the case that a second user account is logged in using the first terminal, acquiring the first identification from the first terminal, determining the first mapping network based on the acquired first identification, and then saving the second user account and the first terminal in a corresponding relationship in the first mapping network.

Optionally, the user account is an account of a buyer in E-commerce; and the preset processing manner comprises: statistically calculating the speed of placing orders by the buyer to whom the user account belongs.

Optionally, the preset processing manner further comprises one or two of the following manners: outputting a delivery address of the buyer; and outputting a network address of a terminal used by the buyer.

A device for determining an information processing target is provided according to another aspect of the present invention.

The device for determining an information processing target of the present invention comprises: a saving module for saving mapping networks formed of many-to-many correspondences between a plurality of user accounts and a plurality of terminals, the terminals being those that are used when at least one of the user accounts are logged in; and a positioning module for using, in the case that a mapping network contains a pre-specified user account or terminal, the user account and/or terminal in the mapping network as an information processing target, and processing the information processing target in a preset processing manner.

Optionally, the saving module is further used for saving a plurality of mapping networks, and combining, in the case that the user account is logged in using a terminal in another mapping network different from the mapping network where the user account is located, the other mapping network and the mapping network where the user account is located into a single mapping network.

Optionally, the saving module is further used for: after a first user account is logged in, transmitting a first identification to a first terminal used to log into the first user account, and saving the first user account and the first identification in a corresponding relationship in a first mapping network; in the case that the first user account is logged in again using a second terminal, transmitting a second identification to the second terminal, and saving the second identification and the first user account in a corresponding relationship in the first mapping network; and in the case that a second user account is logged in using the first terminal, acquiring the first identification from the first terminal, determining the first mapping network based on the acquired first identification, and then saving the second user account and the first terminal in a corresponding relationship in the first mapping network.

According to the technical solution of the present invention, the respective accounts and terminals used by the user are saved in a form of a mapping table, and in the case that a user has a plurality of accounts and/or a plurality of terminals, if any one of the accounts or terminals has once performed a network behavior that leads to being monitored (e.g., maliciously placing an order), all of the accounts and terminals of the user can be determined based on the mapping table, so that the user will be monitored every time the user uses any of his accounts or terminals to log in again. That is to say, the information processing target can be effectively determined according to the technical solution of the present invention.

### BRIEF DESCRIPTION OF THE DRAWINGS

The figures are used for a better understanding of the present invention, and do not constitute improper limitations of the present invention. Wherein:

FIG. 1 is a schematic diagram of the method for determining an information processing target according to an embodiment of the present invention;

FIGS. 2A to 2D are schematic diagrams of the mapping networks according to embodiments of the present invention;

FIG. 3 is a schematic diagram of the basic composite parts of the device for determining an information processing target according to an embodiment of the present invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

The following part will illustrate exemplary embodiments of the present invention with reference to the figures, including various details of the embodiments of the present invention for a better understanding. The embodiments should be regarded only as exemplary ones. Therefore, those skilled in the art should appreciate that various changes or modifications can be made with respect the embodiments described herein without departing from the scope and spirit of the present invention. Similarly, for clarity and conciseness, the descriptions of the known functions and structures are omitted in the descriptions below.

In the actual E-commerce, a buyer generally sticks to one or several terminal devices, and has one or several frequently used accounts. Accordingly, in the present embodiment, after a computer of an internet user accesses a website, an identification is left in the computer, the identification and the terminal (generally the browser) being in a unique correspondence, and the account and the terminal used when logging into the account are saved in a corresponding relationship. Since one account can be successively logged in using a plurality of terminals, and a plurality of accounts can be logged in using the same terminal, the plurality of accounts and the plurality of terminals form many-to-many relationships, and thus are assembled into a mapping network formed of the plurality of accounts and terminals. Since the identification and the terminal are uniquely corresponding, the specific saved content can be the correspondence between the account and the identification. When new request information is received, the mapping network where the account or the terminal is located is identified based on the account to which the request information belongs or based on the identification carried by the terminal which transmits the request information, the respective terminals in this mapping network are the thermals frequently used by the same user, and the accounts frequently used by the user are also in this mapping network. If the user has once maliciously placed an order, it can be almost affirmed that there will be terminals and accounts relating to the malicious placement of the order in the mapping network. The wording “almost affirmed” herein refers to the case that the user may theoretically use an account which has never been used before and use a terminal which has never been used by himself before to log in and maliciously place an order, and in this case, the malicious placement of the order cannot be found by monitoring the accounts and terminals in the above described mapping network. However, in the scenario of a real case, a user may not frequently register new accounts and frequently update the terminal used by himself. The technical solutions of the embodiments of the present invention are described below by taking the figures into consideration.

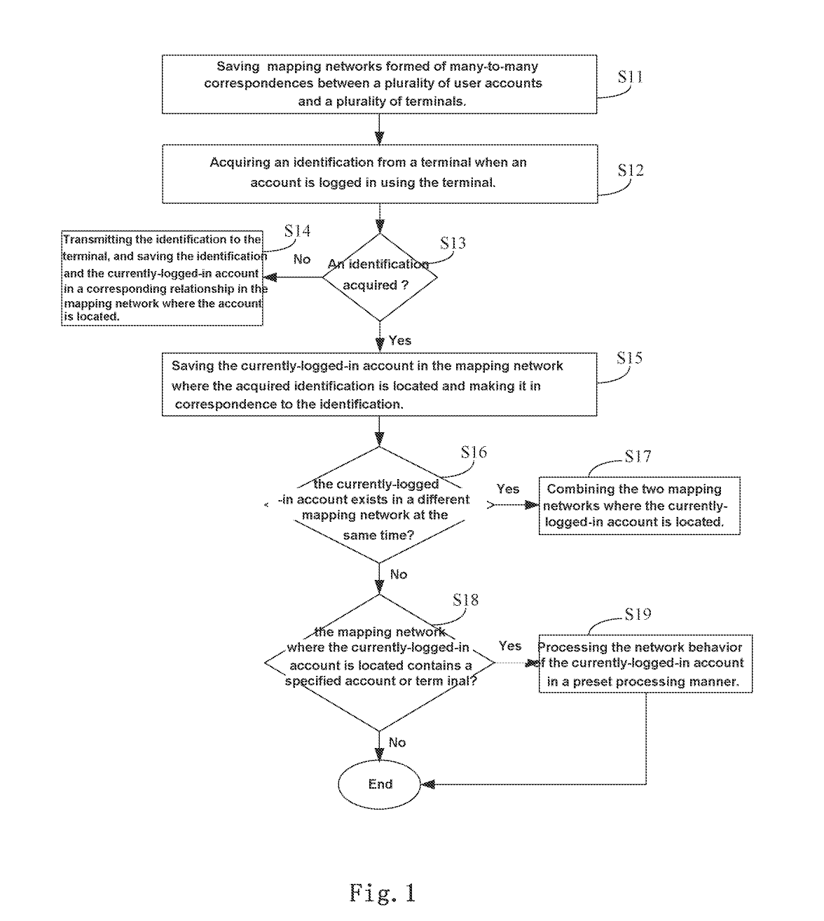

FIG. 1 is a schematic diagram of a method for determining an information processing target according to an embodiment of the present invention. In the present embodiment, a server is used to determine the information processing target, and the information processing target herein refers to the account of the user or the terminal used by the user. As shown in FIG. 1, the method mainly comprises the following steps:

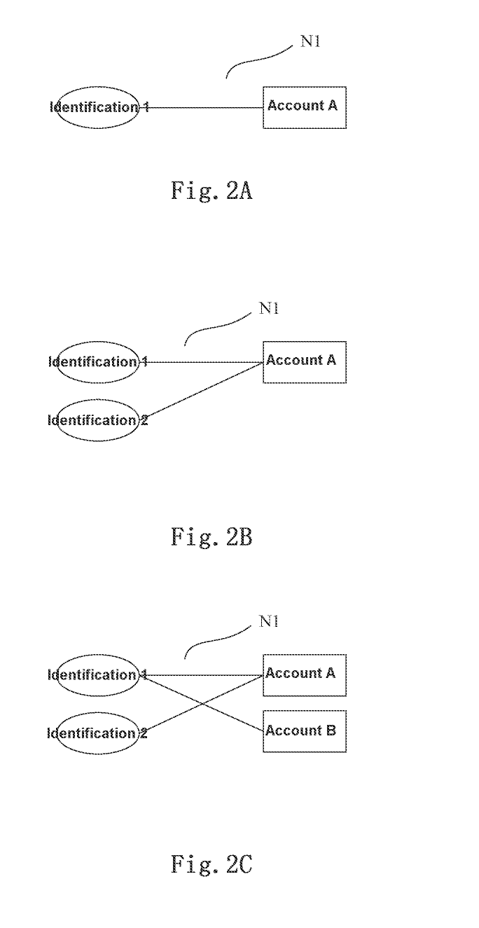

Step S11: Mapping networks formed of many-to-many correspondences between a plurality of user accounts and a plurality of terminals are saved. The terminals herein are those that are used when at least one of the above user accounts are logged in. A mapping network herein is expanded along with the increase of the numbers of the accounts and terminals used by a user. FIGS. 2A to 4A are contemplated below to give illustrations. FIGS. 2A to 2D are schematic diagrams of the mapping networks according to embodiments of the present invention.

After a user uses one of his accounts, e.g., an account A, for the first time to log in on a terminal 1, the server transmits an identification 1 to the terminal 1, and creates a new mapping network N1, in which the identification 1 and the account A are saved in a corresponding relationship, as shown in FIG. 2A. Generally speaking, the user can change the terminal without changing the account to log in, or can change the account and use the same terminal to log in. In the case of changing the terminal without changing the account to log in, the server also transmits an identification 2 to a changed terminal 2, and saves the identification 2 in the mapping network N1 in a correspondence relationship with the account A, as shown in FIG. 2B. In this case, since the server has saved the account A after it was logged in, when the account A is logged in from the terminal 2, the server can identify the mapping network N1 based on the account A. In the case that the account is changed to the account B and the same terminal 1 is used to log in, the server first acquires the identification 1 from the terminal 1, identifies the mapping network N1 based on the identification 1, and then saves the account B in the identified mapping network N1 in a correspondence relationship with the identification 1, as shown in FIG. 2C.

It can be seen that if the terminal used by the user upon a next login is one in which the identification in the mapping network N1 is located but the used account is not one in the mapping network N1, or the used account is one in the mapping network N1 but the used terminal is not one in which the identification in the mapping network N1 is located, the mapping network N1 will be continuously expanded.

A further condition, as shown in FIG. 2D, is that the user firstly uses accounts A to D to log in on terminals 1 to 5 (the identifications for these terminals are, respectively, identifications 1 to 5) to form the mapping network N1; and uses another batch of different accounts E to G to log in on another batch of terminals 6 and 7 (the identifications are, respectively, identifications 6 to 7) to form a mapping network N2; and then the user further uses the account A to log in on the terminal 6. In this case, the mapping networks N1 and D2 are combined to form a single mapping network N12. That is to say, in the case that a certain account is logged in using a terminal in another mapping network different from the mapping network in which the account is located, these two mapping networks are combined into a single mapping network.

It can be seen that the mapping network may be expanded to cover almost all of accounts and terminals of one user, and the network behaviors (logging in, placing an order and the like) of the user are related to the mapping table. In the case that one or more mapping networks exist, these mapping networks can be used to determine the user accounts and/or terminals to be monitored. It should be noted that the process of establishing the mapping networks and the use of the mapping networks to determine the user accounts and/or terminals to be monitored are performed synchronously, and in the process of the accounts being continuously logged in, the mapping networks are increased or combined.

Step S12: When an account is logged in using a terminal, an identification is acquired from the terminal. In this step, the login page provided by the server to the terminal contains a script to acquire the identification which has been once transmitted to the terminal.

Step S13: It is judged whether the identification is acquired. If yes, the method proceeds to Step S15, and if no, the method proceeds to Step S14.

Step S14: The identification is transmitted to the terminal, and the identification and the account currently logged in are saved in a corresponding relationship in the mapping network where the account is located. In this step, if the account already exists in a mapping network, the identification is directly saved in a corresponding relationship in the mapping network; otherwise, a mapping network is newly established. After this step, the method proceeds to Step S18 directly.

Step S15: The account currently logged in is saved in the mapping network where the acquired identification is located and is made to correspond to the identification. Since the identification can be acquired, it is indicated that the terminal has been once used to log in, so the terminal must be saved in one mapping network. For the same reason, if the account currently logged in has been once logged in, it will also be saved in one mapping network. Therefore, if the account is logged in using a terminal in another mapping network different from the mapping network where the account is located, and these two mapping networks can be combined, as noted in Step S16 and Step S17.

Step S16: It is judged whether the account currently logged in exists in different mapping networks at the same time. If yes, Step S17 is entered, and if no, Step S18 is entered.

Step S17: The two mapping networks where the account currently logged in is located are combined.

Step S18: It is judged whether the mapping network where the account currently logged in is located contains a specified account or terminal. Since the account currently logged in and the terminal used thereby must be in the same mapping network, it can be judged in this step whether the mapping network in which the terminal used by the account currently logged in is located contains the specified account or terminal.

In the present embodiment, if the user has once maliciously placed an order, the account used thereby and the identification assigned to the terminal used to log in are both recorded in a mapping network, and become the specified account and terminal. In this case, the accounts and the terminals in the mapping network become targets to be monitored. If the user changes the account or the terminal and then places an order, thanks to the existence of the above mapping network, the changed account or the changed terminal is generally still within the mapping network, and therefore becomes targets to be monitored, unless the user uses a new account and a new terminal. And the new account and the new terminal will also be recorded in a new mapping network, and if the new account is logged in using any terminal in the previously-mentioned mapping network, or any account in the previously-mentioned mapping network is logged in using the new terminal, the previously-mentioned mapping network and the new mapping network will be combined, and the new account and the new terminal will also become targets to be monitored.

When the result of the judgment at Step S18 is “YES”, it indicates that the current user has once maliciously placed an order, so the flow proceeds to Step S19; otherwise, the flow is ended. The above takes the “malicious placement of an order” as the reason for specifying an account and a terminal. The specifying can be also performed based on other reasons.

Step S19: The network behavior of the account currently logged in is processed in a preset processing manner. In the field of E-commerce, when the behavior of maliciously placing an order is monitored, it is general rule to use the speed of placing orders of an account of a buyer, i.e., the number of orders placed within a unit time, to measure whether a malicious placement of an order is performed, and the server can detect and output the speed of placing orders of the account in real time. When the E-commerce operator finds that the speed of placing orders is comparatively fast, a corresponding measure, e.g., freezing the account, manually contacting the user and the like, can be adopted. In addition, the server can also monitor the delivery address of the buyer and/or the network address of the terminal and perform the output to be referred to by the E-commerce operator.

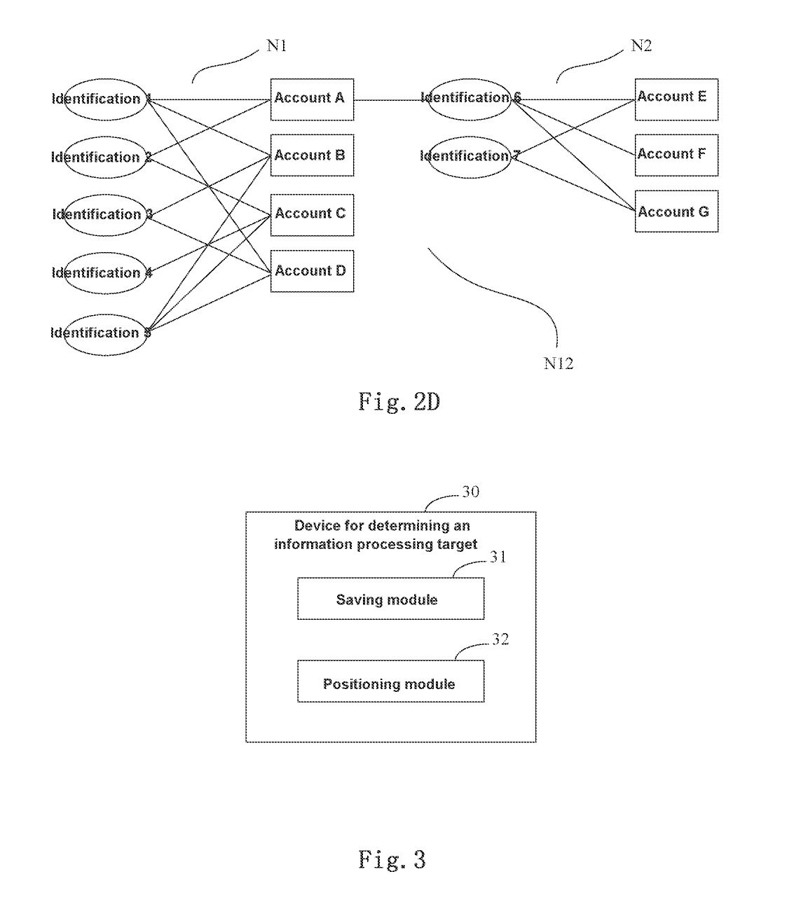

FIG. 3 is a schematic diagram of the basic composite parts of a device for determining an information processing target according to an embodiment of the present invention. As shown in FIG. 3, a device 30 for determining an information processing target mainly comprises a saving module 31 and a positioning module 32.

The saving module 31 is used for saving mapping networks formed of many-to-many correspondences between a plurality of user accounts and a plurality of terminals, the terminals being those that are used when at least one of the user accounts are logged in. The positioning module 32 is used for using, in the case that a mapping network contains a pre-specified user account or terminal, the user account and/or terminal in the mapping network as an information processing target, and processing the information processing target in a preset processing manner.

The saving module 31 can be further used for saving a plurality of mapping networks, and combining, in the case that a user account is logged in using a terminal in another mapping network different from the mapping network where the user account is located, the other mapping network and the mapping network where the user account is located into a single mapping network.

The saving module 31 can be further used for: after a first user account is logged in, transmitting a first identification to a first terminal used to log into the first user account, and saving the first user account and the first identification in a corresponding relationship in a first mapping network; in the case that the first user account is logged in again using a second terminal, transmitting a second identification to the second terminal, and saving the second identification and the first user account in a corresponding relationship in the first mapping network; and in the case that a second user account is logged in using the first terminal, acquiring the first identification from the first terminal, determining the first mapping network based on the acquired first identification, and then saving the second user account and the first terminal in a corresponding relationship in the first mapping network.

According to the technical solution of the present invention, the respective accounts and terminals used by the user are saved in a form of a mapping table, and in the case that a user has a plurality of accounts and/or a plurality of terminals, if any one of the accounts or terminals has once performed a network behavior that leads to being monitored (e.g., maliciously placing an order), all of the accounts and terminals of the user can be determined based on the mapping table, so that the user will be monitored when the user uses any of his accounts or terminals to log in again. That is to say, the information processing target can be effectively determined according to the technical solution of the present invention.

The above describes the basic principles of the present invention with reference to the specific embodiments. However, it is necessary to point out that those skilled in the art can understand that all or any step or part of the method and device of the present invention can be realized through hardware, firmware, software or a combination thereof in any computing device (including a processor, a storage medium, etc.) or a network of a computing device. This can be realized by those skilled in the art by applying their basic programming skills after they read the descriptions of the present invention.

So, the purpose of the present invention can be also achieved by running a program or a set of programs on any computing device. The computing device can be a general device known. Therefore, the purpose of the present invention can be also achieved only by providing a program product including program codes realizing the method or device. That is to say, such a program product also constitutes the present invention, and a storage medium storing such a program product also constitutes the present invention. Obviously, the storage medium can be any known storage medium or any storage medium developed in the future.

It is further necessary to point out that in the device and method of the present invention, the respective parts or the respective steps obviously can be decomposed and/or recombined. These decompositions and/or recombinations shall be regarded as equivalent solutions of the present invention. And the steps performing the above series of processings can be naturally performed in a time sequence based on the described sequence, but are not necessarily performed in the time sequence. Some steps can be performed in parallel or independently of each other.

The above specific embodiments do not constitute a restriction on the scope of protection of the present invention. Those skilled in the art shall understand that, based on design requirements and other factors, various modifications, combinations, sub-combinations and substitutions can occur. Any modifications, equivalent substitutions, improvements, etc. within the spirit and principle of the present invention shall be included in the scope of protection of the present invention.

What is claimed is:

1. A method for determining an information processing target, comprising:
saving mapping networks formed of many-to-many correspondences between a plurality of user accounts and a plurality of terminals, the terminals being those that are used when at least one of the user accounts are logged in; and
using, in the case that a mapping network contains a pre-specified user account or terminal, the user account and/or terminal in the mapping network as an information processing target, and processing the information processing target in a preset processing manner.

2. The method according to claim 1, wherein the saved mapping networks are plural, and the method further comprises:
in the case that the user account is logged in using a terminal in another mapping network different from the mapping network where the user account is located, combining the other mapping network and the mapping network where the user account is located into a single mapping network.

3. The method according to claim 1, wherein the step of saving mapping networks formed of many-to-many correspondences between a plurality of user accounts and a plurality of terminals comprises:
after a first user account is logged in, transmitting a first identification to the first terminal used to log into the first user account, and saving the first user account and the first identification in a corresponding relationship in a first mapping network;
in the case that the first user account is logged in again using a second terminal, transmitting a second identification to the second terminal, and saving the second identification and the first user account in a corresponding relationship in the first mapping network; and
in the case that a second user account is logged in using the first terminal, acquiring the first identification from the first terminal, determining the first mapping network based on the acquired first identification, and then saving the second user account and the first terminal in a corresponding relationship in the first mapping network.

4. The method according to claim 1, wherein:
the user account is an account of a buyer in E-commerce; and
the preset processing manner comprises: statistically calculating the speed of placing orders by the buyer to whom the user account belongs.

5. The method according to claim 4, characterized in that the preset processing manner further comprises one or two of the following manners:
outputting a delivery address of the buyer; and
outputting a network address of a terminal used by the buyer.

6. A device for determining an information processing target, comprising:
a saving module for saving mapping networks formed of many-to-many correspondences between a plurality of user accounts and a plurality of terminals, the terminals being those that are used when at least one of the user accounts are logged in; and
a positioning module for using, in the case that a mapping network contains a pre-specified user account or terminal, the user account and/or terminal in the mapping network as an information processing target, and processing the information processing target in a preset processing manner.

7. The device according to claim 6, wherein
the saving module is further used for saving a plurality of mapping networks, and combining, in the case that a user account is logged in using a terminal in another mapping network different from the mapping network where the user account is located, the other mapping network and the mapping network where the user account is located into a single mapping network.

8. The device according to claim 6, wherein the saving module is further used for:
after a first user account is logged in, transmitting a first identification to a first terminal used to log into the first user account, and saving the first user account and the first identification in a corresponding relationship in a first mapping network; in the case that the first user account is logged in again using a second terminal, transmitting a second identification to the second terminal, and saving the second identification and the first user account in a corresponding relationship in the first mapping network; and in the case that a second user account is logged in using the first terminal, acquiring the first identification from the first terminal, determining the first mapping network based on the acquired first identification, and then saving the second user account and the first terminal in a corresponding relationship in the first mapping network.
